(19) United States
(12) Patent Application Publication
(10) Pub. No.: US 2024/0161489 A1
(43) Pub. Date: May 16, 2024

(54) Quantization at Different Levels for Data Used in Artificial Neural Network Computations

(71) Applicant: Micron Technology, Inc., Boise, ID (US)

(72) Inventors: Saideep Tiku, Folsom, CA (US); Shashank Bangalore Lakshman, Folsom, CA (US); Poorna Kale, Folsom, CA (US)

(21) Appl. No.: 18/500,672

(22) Filed: Nov. 2, 2023

Related U.S. Application Data
(60) Provisional application No. 63/383,199, filed on Nov. 10, 2022.

(51) Int. Cl. G06V 10/82; G06F 7/544; G06T 11/00; G06V 10/22; G06V 10/24; G06V 10/94; G06V 20/20

(52) U.S. Cl. CPC G06V 10/82; G06F 7/5443; G06T 11/00; G06V 10/22; G06V 10/24; G06V 10/955; G06V 20/20

(57) ABSTRACT

A pair of smart glasses having: a digital camera configured to capture an image of a field of view; and a processing device configured to perform an analysis of the image using an artificial neural network having weight data. The processing device can apply different quantization levels to data from different regions of the image, and apply the different quantization levels to the weight data in weighing on the data from the different regions respectively. For example, weighing image data from a peripheral region of the image with the weight data can be performed with a lower level of accuracy than weighing image data from a center region of the image with the weight data to reduce energy consumption. Based on an output of the artificial neural network responsive to the image, the glasses can present virtual content superimposed on a view of reality seen through the glasses.

### RELATED APPLICATIONS

The present application claims priority to Prov. U.S. Pat. App. Ser. No. 63/383,199 filed Nov. 10, 2022, the entire disclosures of which application are hereby incorporated herein by reference.

### TECHNICAL FIELD

At least some embodiments disclosed herein relate to image processing in general and more particularly, but not limited to, image processing using artificial neural network.

### BACKGROUND

Computations of an artificial neural network (ANN) can be formulated based on artificial neurons generating outputs in response to weighted sums of inputs. Performing the operations of multiplication and accumulation to determine weighted sums of inputs to artificial neurons, with weights and inputs represented by floating point numbers, can require large memory sizes to store the floating point numbers and complex circuits to operate on the floating point numbers.

Quantization includes constraining an input to a reduced set of choices. For example, quantization can be applied to constrain the floating point numbers used in the computations of an artificial neural network (ANN) to integer numbers having a fixed, low bit width. Performing the operations of multiplication and accumulation to determine weighted sums of inputs to artificial neurons, with weights and inputs represented by the integer numbers of the low bit width, can reduce the requirements on memory sizes for memory sub-systems used to store the integer numbers and simplify the circuits to operate on the integer numbers.

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 shows a technique of applying different levels of quantization to inputs and weights based on locations of the inputs according to one embodiment.

FIG. 2 illustrates an operation of combining image data and weight data according to a level of quantization selected for the image data according to one embodiment.

FIG. 3 illustrates an application of quantization at different levels adapted according to a perception or vision characteristics of human ocular focus according to one embodiment.

FIG. 4 shows an integrated circuit device having an image sensing pixel array, a memory cell array, and circuits to perform inference computations according to one embodiment.

FIG. 5 and FIG. 6 illustrate different configurations of integrated imaging and inference devices according to some embodiments.

FIG. 7 shows the computation of a column of weight bits multiplied by a column of input bits to provide an accumulation result according to one embodiment.

FIG. 8 shows the computation of a column of multi-bit weights multiplied by a column of input bits to provide an accumulation result according to one embodiment.

FIG. 9 shows the computation of a column of multi-bit weights multiplied by a column of multi-bit inputs to provide an accumulation result according to one embodiment.

FIG. 10 shows a computing system configured to process an image using an integrated circuit device and an artificial neural network according to one embodiment.

FIG. 11 shows another computing system according to one embodiment.

FIG. 12 shows an implementation of artificial neural network computations according to one embodiment.

FIG. 13 shows an image processing logic circuit using an inference logic circuit in image compression according to one embodiment.

FIG. 14 shows a method of image processing according to one embodiment.

### DETAILED DESCRIPTION

At least some embodiments disclosed herein provide techniques of image processing at different quantization levels adapted according to a perception or vision characteristics of human ocular focus, where what is in the center of a field of vision is seen clearer than what is on the periphery of the field of vision.

In at least some embodiments, quantization of both image data and weight data to be applied to weigh the image data is configured at multiple levels to emulate the perception or vision characteristics of human ocular focus.

For example, image data and corresponding weight data for an image region of more interest (e.g., the center region of an image to be analyzed by an artificial neural network to recognize, extract, classify, or identify objections) is applied quantization simultaneously at a level that is more accurate than the quantization level applied to an image region of less interest (e.g., a peripheral region of the image).

For example, a same weight matrix can be configured to be applied to weigh a unit of image data to generate weighted and summed inputs to a set of artificial neurons. Such a unit of image data can be for a block of pixels of a predetermined number of rows and a predetermined number of columns, where the blocks of pixel can be in any of the different regions (e.g., center region, intermediate region, transition region, peripheral region). The same weight matrix of high accuracy can be applied to different units of image data from the different regions of an image to perform the computation of the artificial neural network at the same accuracy level.

To emulate the perception or vision characteristics of human ocular focus, the weight matrix can be quantized to generate a plurality of quantized weight matrices at different levels of accuracy. For example, data elements in a quantized weight matrix at a high level of accuracy can be each represented by integer numbers of a fixed width of a high number of bits; and data elements in a quantized weight matrix at a low level of accuracy can be each represented by integer numbers of a fixed width of a low number of bits. Thus, a same weight can be represented by different integer numbers of different bit widths configured for different quantization levels respectively, although the ratio between an integer number representative of a quantized weight at a given level of accuracy and the range of possible integer numbers representative of different quantized weights at the same level of accuracy can be the same across the quantization levels.

For example, quantization of a number for a level of accuracy can be performed efficiently via bitwise shifting to remove less significant bits and retain a predetermined number of most significant bits; and quantization configured for different levels of accuracy can be configured to retain different numbers of most significant bits and thus different bit widths.

When a unit of image data is from an image region that is of high interest (e.g., center region), the unit of image data can be quantized at a high level of accuracy to generate a quantized unit of image data, where each integer number has a high bit width. A quantized weight matrix at the same high level of accuracy can be selected and used to weigh the quantized unit of image data. Multiplication and accumulation can be applied to the quantized unit of image data and the quantized weight matrix, having matching high accuracy levels, in generating weighted sum of inputs. The result of the multiplication and accumulation (e.g., as inputs to a set of artificial neurons) has a high level of accuracy, which corresponds to the high quantization level applied to both the weight matrix and the unit of image data.

In contrast, when a unit of image data is from an image region that is of low interest (e.g., peripheral region), the unit of image data can be quantized at a low level of accuracy to generate a quantized unit of image data, where each integer number has a low bit width. A quantized weight matrix at the same matching level of accuracy can be selected and used to weigh the quantized unit of image data. Multiplication and accumulation can be applied to the quantized unit of image data and the quantized weight matrix, having matching low accuracy levels, in generating weighted sum of inputs. The result of the multiplication and accumulation has a low level of accuracy corresponding to the low quantization level applied to both the weight matrix and the unit of image data.

Thus, the computation results have an accuracy characteristics emulating the perception or vision characteristics of human ocular focus: the results for the image data computed for the region of interest (e.g., center region) are more accurate (e.g., corresponding to clearer vision) than the results for the image data computed for region of less interest (e.g., peripheral region).

Since the computations for image data in regions of less interest are configured to use a smaller number of bits, the performance of the computations consumes less energy, which leads to savings in overall energy consumption.

Similar to perception through human ocular focus, the quality of the analysis of the artificial neural network (e.g., in object detection, extraction, identification, classification) can be degraded in the regions of less interest (e.g., peripheral region of the image representative of what is in the field of vision of an eye of a user).

The techniques to reduce energy consumption by reducing the computation accuracy through quantization in image regions of less interest can be applied in context-aware applications, such as augmented reality (AR) presented via smart glasses.

Augmented reality (AR) glasses can be configured to capture and analyze an image of the field of view in front of a user. Objects in the image can be analyzed to recognize objects; and information about or related to the recognized objects can be presented to the user using the glasses to augment the reality seen through the glasses.

Since a typical user is less concerned about the objects in their peripheral vision, degrading the accuracy in recognizing the objects appearing in the peripheral vision in exchange for reduced energy consumption can be beneficial and desirable.

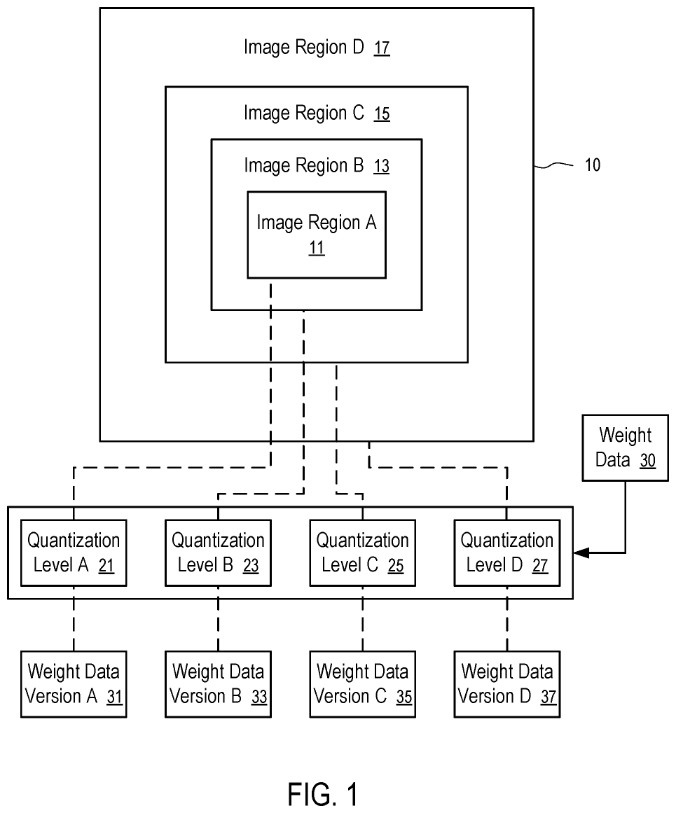

FIG. 1 shows a technique of applying different levels of quantization to inputs and weights based on locations of the inputs according to one embodiment.

For example, in an image 10 illustrated in FIG. 1, contents in different regions (e.g., 11, 13, 15, 17) can be of different levels of interest as a result of a point of focus of the attention of a user being at a central region 11.

For example, if the image 10 is projected on the retina of a human eye to form a field of vision, the visual system of the person forms a clearer vision or perception of the center region (e.g., 11) than the periphery (e.g., region 17).

To emulate such a vision or perception characteristics of human ocular focus, the data used in the analysis of the image can be quantized at different levels of accuracy. More accurate computations can be performed for regions of higher levels of interest (e.g., the center region 11); and less accurate computations (and thus less demanding in computation efforts and energy expenditure) can be performed for regions of lower levels of interest (e.g., the regions 13, 15, and 17).

For example, a set of quantization levels 21, 23, 25, 27 can be constructed to have varying accuracy levels, ranked from highest to lowest respectively. Data quantized at each quantization level (e.g., 21, 23, 25, or 27) can be represented via integer numbers having a respective bit width; and the bit width of the quantization level (e.g., 21, 23, 25, or 27) reduces as its quantization level of accuracy reduces.

For example, the bit width of the quantization level can be configured to decrease by one bit (or another predetermined number of bits) for each decrement in accuracy level.

The quantization levels 21, 23, 25, and 27 can be applied to the image data from the regions 11, 13, 15, and 17, and also applied to the weight data 30.

For example, when the quantization level 21 is applied to the image data from the region 11, the same quantization level 21 is also applied to the weight data 30 to generate weight data version 31 used in computations performed to weigh on the image data from the region 11.

Similarly, when the quantization level 27 is applied to the image data from the region 17, the same quantization level 27 is also applied to the weight data 30 to generate weight data version 37 used in computations performed to weigh on the image data from the region 17.

For example, an artificial neural network can be configured to apply a weight matrix as the weight data 30 to a unit of image data representative of a block of pixels of a predetermined size (e.g., having a predetermined rows of pixels and a predetermined columns of pixels). When the accuracy of the computation of the artificial neural network is not adjusted via quantization based on the interest levels of the regions, a unit of image data from the peripheral image region 17 and a unit of image data from the central image region 11 can be both applied the same weight matrix without quantization (or with the highest quantization level 21).

To reduce energy consumption with blurry computation for regions of less interest, units of image data from the regions 11, 13, 15, and 17 can be applied to the decreasing quantization levels 21, 23, 25, and 27 respectively. Further, the weight data 30 can be applied to the quantization levels 21, 23, 25, and 27 respectively as well for the weighting of the image data from the regions 11, 13, 15, and 17.

Thus, the image data from the different regions (e.g., 11, 13, 15, 17) are applied versions (e.g., 31, 33, 35, 37) of the weight data 30 at quantized at matching levels of accuracy for the respective image data in generating weighted sums of inputs.

FIG. 1 illustrates an example of dividing the image 10 into four regions 11, 13, 15, and 17. In general, more or less numbers of regions can be used in configuring quantization variations for an image 10.

Further, the shapes and sizes of the regions (e.g., 11, 13, 15, 17) can be adjusted based on a model of the distribution of clearness in the perception or vision of a vision field of human ocular focus. Optionally, the model of clearness/accuracy distribution can be personalized for a user (e.g., based on a test of vision of the user). For example, when the user has a poor peripheral vision, the size of the peripheral region 17 can be enlarged and, optionally, quantized more aggressively. For example, an interactive graphical user interface can be used to receive inputs from a user to adjust the size and shape of the image regions 11, 13, 15, and 17 for the quantization levels 21, 23, 25, and 27.

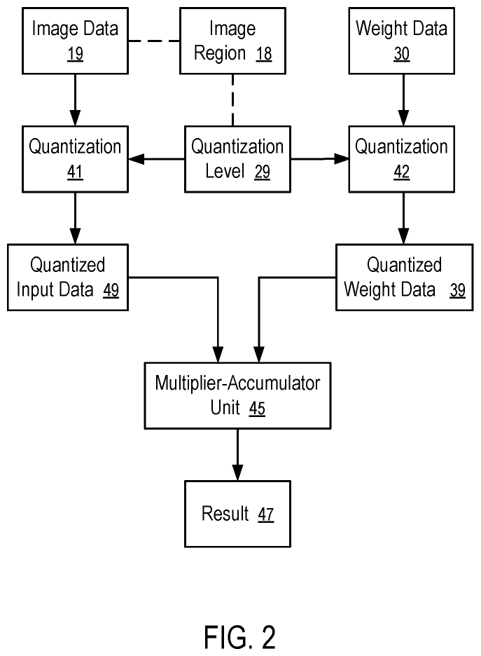

FIG. 2 illustrates an operation of combining image data and weight data according to a level of quantization selected for the image data according to one embodiment.

For example, the technique of FIG. 1 can be used in the operation of FIG. 2.

In FIG. 2, image data 19 is to be weighted based on weight data 30 to generate a result 47 (e.g., via multiplication and accumulation as a set of weighted and summed inputs to artificial neurons).

For example, the image data 19 can be configured to be representative of a block of pixels of a predetermined size, having a predetermined number of rows of pixels and a predetermined number of columns of pixels.

Optionally, the image data 19 and the weight data 30 can be quantized at a highest desirable accuracy level such that the data elements in the image data 19 and the weight data 30 are represented by integer numbers of a predetermined bit width.

When an entire image 10 is to be analyzed at the highest accuracy level, a multiplier-accumulator unit 45 can operate on the image data 19 and the weight data 30 directly to obtain the result 47, without considering the image region 18 (e.g., 11, 13, 15, or 17) from which the image data 19 retrieved.

To apply different quantization levels (e.g., 21, 23, 25, 27) to the analyses of image data from different image regions (e.g., 11, 13, 15, or 17) having different levels of interest for a user, the image region 18 from which the image data 19 is retrieved is used to identify a quantization level 29 (e.g., 21, 23, 25, 27) for the respective image region 18 (e.g., region 11, 13, 15, 17).

The quantization level 29 controls the operations of quantization 41 and 42 applied to the image data 19 and the weight data 30 respectively to generate the quantized input data 49 and the quantized weight data 39 that have matching accuracy levels.

The multiplier-accumulator unit 45 operates on the quantized input data 49 and the quantized weight data 39 to generate the result 47 having an accuracy level corresponding to the quantization level 29 specified for the image region 18.

In some implementations, the quantization level 29 specifies a number of most significant bits to be used in the computation in the multiplier-accumulator unit 45. The operations of quantization 41 and 42 can be configured as skipping operating on the least significant bits that identified, according to the quantization level 29, to be excluded from the computation in the multiplier-accumulator unit 45.

For example, the least significant bits identified by the quantization level 29 for exclusion from the computation in the multiplier-accumulator unit 45 can be considered zeros; and the results from operating on the least significant bits identified for exclusion are known to be zeros at the quantization level 29 and thus can be used directly to reduce energy consumption and computing time associated with operating on the least significant bits identified for exclusion.

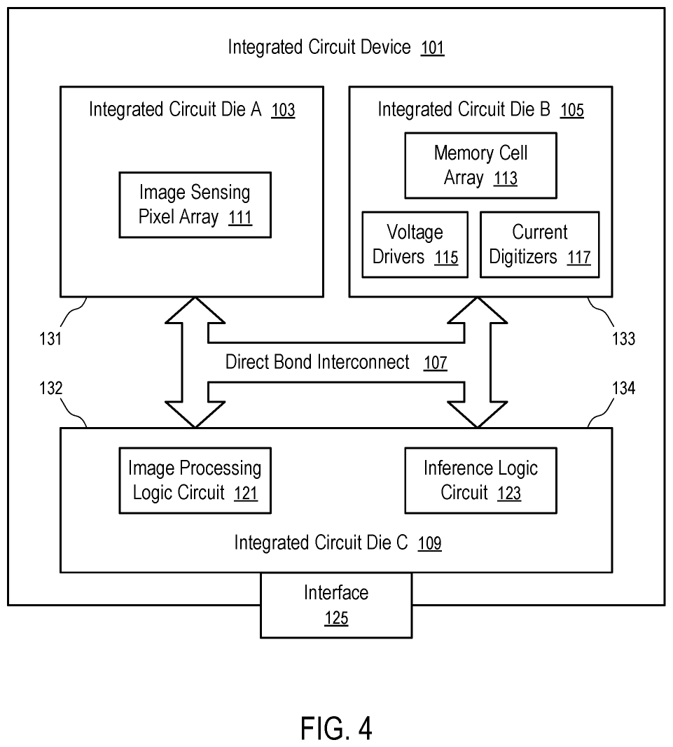

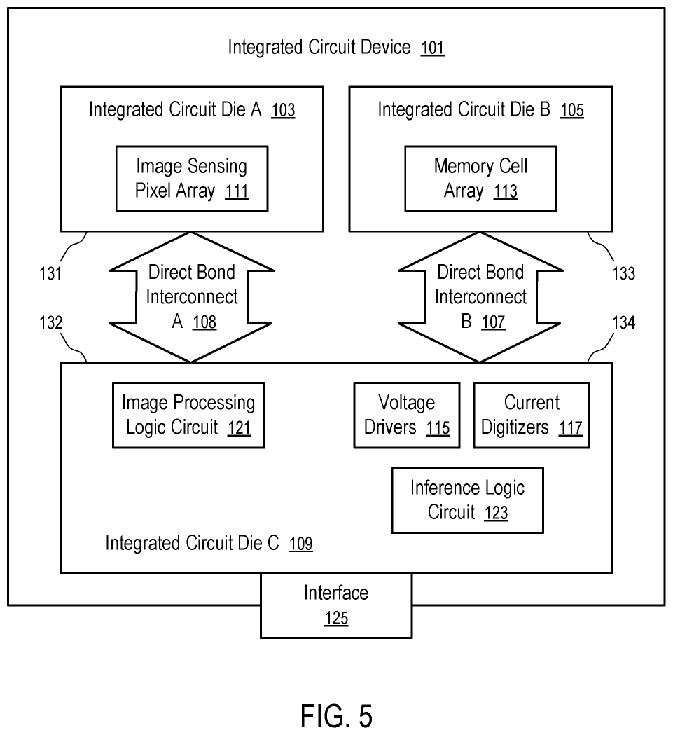

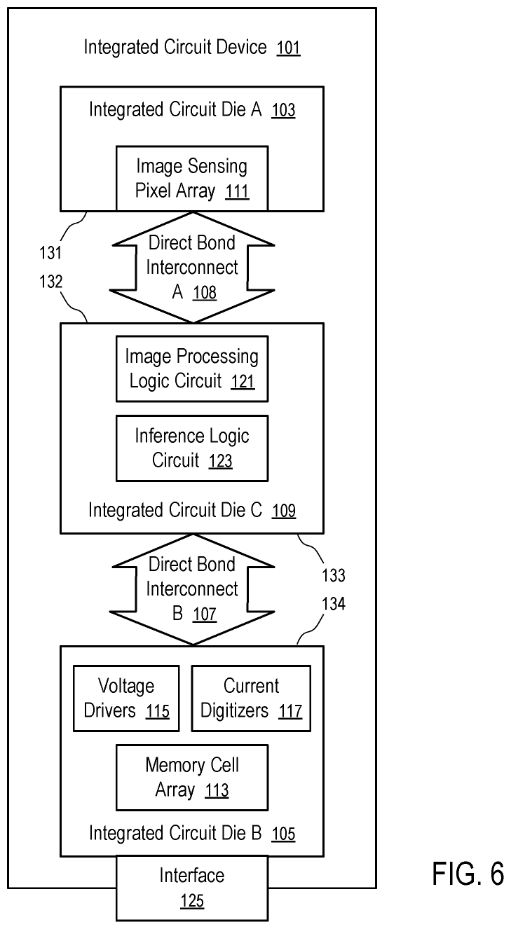

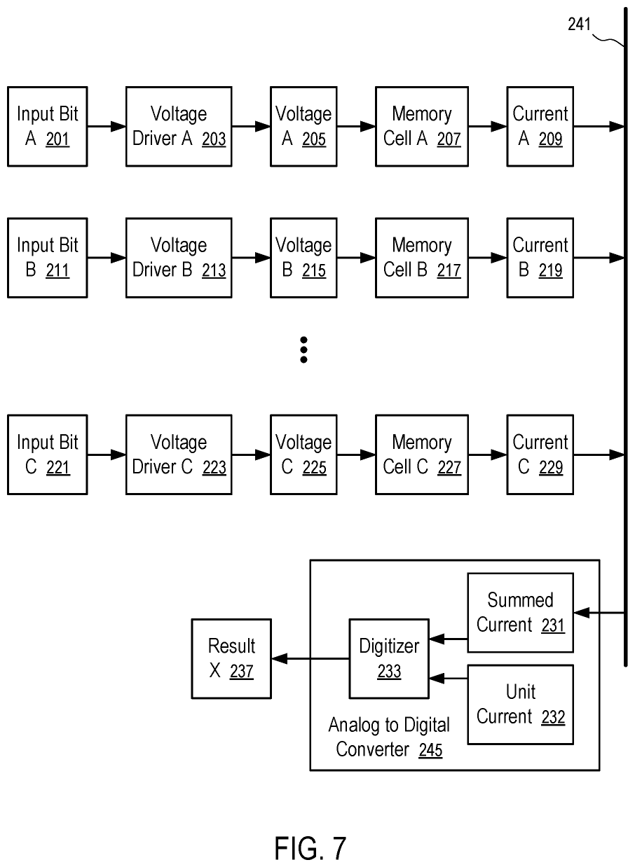

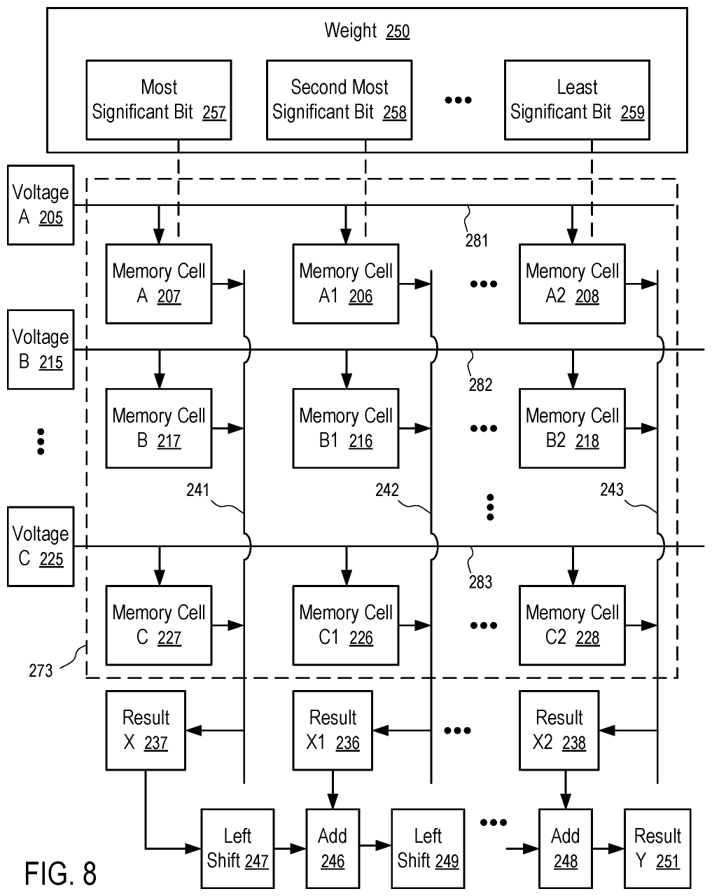

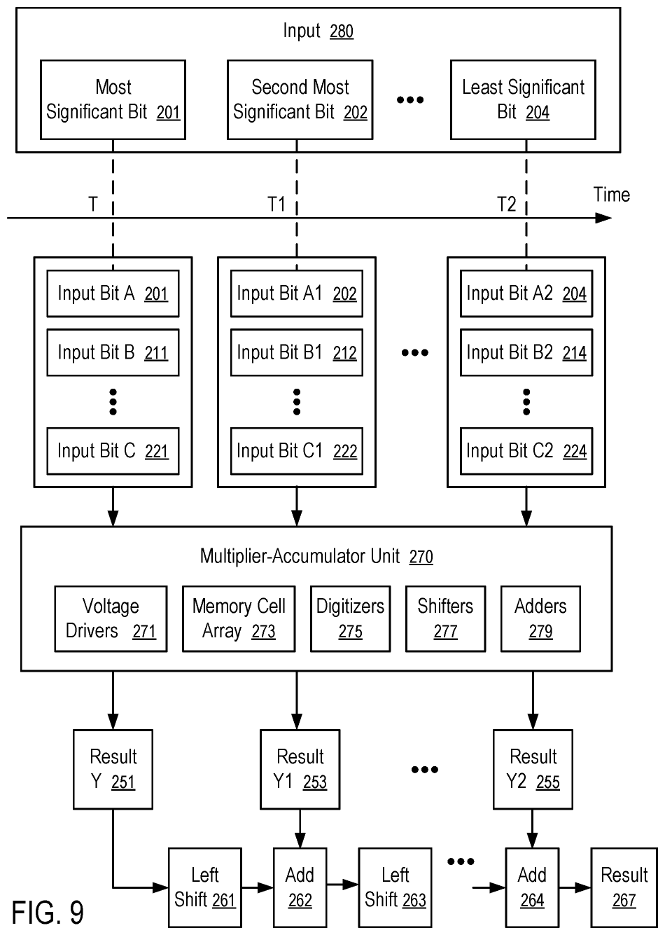

For example, the multiplier-accumulator unit 45 can be implemented via an integrated circuit device 101 of FIG. 4, FIG. 5, or FIG. 6, where multiplication and accumulation can be performed as in FIG. 7, FIG. 8, and FIG. 9, which are discussed in detail further below.

When the quantization level 29 indicates the exclusion of the least significant bit of inputs to be applied at time T2 in FIG. 9, the computation to be performed at the time T2 can be skipped; and zero can be used as the result 255 in computing the result 267. Optionally, the operation of add 264 can also be skipped, since the result 255 is zero for quantization level 29.

Similarly, when the quantization level 29 indicates the exclusion of the least significant bits stored in the memory cells 208, 218, . . . , 228 connected to the bitline 243 in FIG. 8, the application of the voltages 205, 215, . . . , 225 to the memory cells 208, 218, . . . , 228 connected to the bitline 243 can be skipped to cause the bitline 243 to have a negligible amount of current; and zero can be used as the result 238 in computing the result 267. Optionally, the operation of add 248 can also be skipped, since the result 238 is zero for the quantization level 29.

When such techniques are used, it is not necessary to separately store the different weight data versions 31, 33, 35, and 37 for the quantization levels 21, 23, 25, and 27. The same weight data 30 stored in the memory cell array 273 has different weight data versions 31, 33, 35, and 37 stored in sub-sets of the memory cell array 273 in a ready-to-use format. The operations of the multiplier-accumulator unit 45 can be adjusted, as discussed above, according to the quantization level 29 to skip the use of certain columns of memory cells (e.g., memory cells 208, 218, . . . , 228 connected to a bitline 243) and to skip the computation at certain times (e.g., T2) to reduce energy consumption and thus accuracy according to the quantization level 29.

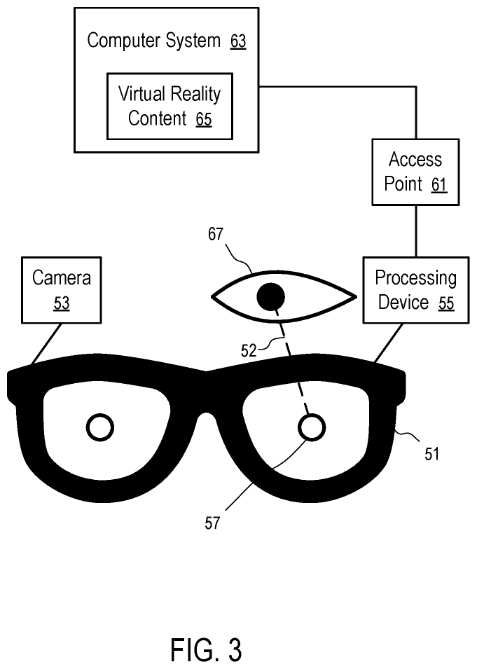

FIG. 3 illustrates an application of quantization at different levels adapted according to a perception or vision characteristics of human ocular focus according to one embodiment.

For example, the technique of FIG. 1 and the operation of FIG. 2 can be implemented in the application illustrated in FIG. 3.

In FIG. 3, a pair of glasses 51 can be configured as a display device to augment the reality as seen by an eye 67 of a user.

A digital camera 53 can include an array of image sensing pixel array to capture an image 10 of what is in the vision field of the eye 67.

Optionally, the glasses 51 can include another camera (or device) to monitor and track the direction of gaze 52 of the eye 67; and a center region 11 of the image 10 can be identified based on the direction of gaze 52. Alternatively, the direction of gaze 52 can be assumed to go through the center portion 57 of a lens of the glasses 51.

The image 10 can be analyzed via a processing device 55 to recognize one or more objects in the image 10. The processing device 55 can be connected to a computer system 63 via an access point 61 to present virtual reality content 65 superimposed on the vision field of the eye 67.

For example, the computer system 63 can be a mobile phone, a personal computer, or a server computer. The access point 61 can be an access point of a wireless local area network, or a base station of a telecommunications network.

The perception or vision characteristics of human ocular focus indicates that the user sees the center image region 11 more clearly than the peripheral image region 17 and thus is more interested in the objects in the center image region 11 than objects in the peripheral image region 17. Thus, it can be advantageous and desirable to analyze the center image region 11 with accuracy higher than the peripheral image region 17 in object recognition, extraction, identification, and classification. Accuracy degradation in regions (e.g., 17) of less interest in exchange for reduced energy expenditure (e.g., powered by a limited battery pack mounted on the glasses 51) can be beneficial and desirable.

Thus, in the object recognition, extraction, identification, and classification performed using an artificial neural network implemented in the processing device 55, different quantization levels 21, 23, 25, and 27 of image data 19 and weight data 30 can be applied based on the identification of the image region 18 (e.g., whether from the image region 11, 13, 15, or 17), as in FIG. 1 and FIG. 2.

The camera 53 and the processing device 55 can be implemented at least in part using an integrated circuit device 101 of FIG. 4, FIG. 5, or FIG. 6.

In some implementations, the processing device 55 is implemented via an image processing circuit or a microprocessor connected locally to the memory cell array storing weight data 30 via a high speed interconnect or computer bus.

Optionally, the image sensing pixel array of the digital camera 53, the memory cell array storing the weight data 30, and a portion of the processing device 55 can be integrated in an integrated circuit device in FIG. 4, FIG. 5, and FIG. 6. The integrated circuit device can be configured with an analog capability to support inference computations, such as computations of multiplication and accumulation, and computations of an artificial neural network. In such an integrated circuit device, an image sensor chip containing the image sensing pixel array 111 and a memory chip containing the memory cell array 113 can be bonded to a logic wafer containing logic circuits to facilitate the computations of multiplication and accumulation, and computations of an artificial neural network having an image as an input, to perform image enhancement, to perform image compression, etc.

For example, the memory chip can be connected directly to a portion of the logic wafer via heterogeneous direct bonding, also known as hybrid bonding or copper hybrid bonding.

Direct bonding is a type of chemical bond between two surfaces of material meeting various requirements. Direct bonding of wafers typically includes pre-processing wafers, pre-bonding the wafers at room temperature, and annealing at elevated temperatures. For example, direct bonding can be used to join two wafers of a same material (e.g., silicon); anodic bonding can be used to join two wafers of different materials (e.g., silicon and borosilicate glass); eutectic bonding can be used to form a bonding layer of eutectic alloy based on silicon combining with metal to form a eutectic alloy.

Hybrid bonding can be used to join two surfaces having metal and dielectric material to form a dielectric bond with an embedded metal interconnect from the two surfaces. The hybrid bonding can be based on adhesives, direct bonding of a same dielectric material, anodic bonding of different dielectric materials, eutectic bonding, thermocompression bonding of materials, or other techniques, or any combination thereof.

Copper microbump is a traditional technique to connect dies at packaging level. Tiny metal bumps can be formed on dies as microbumps and connected for assembling into an integrated circuit package. It is difficult to use microbumps for high density connections at a small pitch (e.g., 10 micrometers). Hybrid bonding can be used to implement connections at such a small pitch not feasible via microbumps.

The image sensor chip can be configured on another portion of the logic wafer and connected via hybrid bonding (or a more conventional approach, such as microbumps).

In one configuration, the image sensor chip and the memory chip are placed side by side on the top of the logic wafer. Alternatively, the image sensor chip is connected to one side of the logic wafer (e.g., top surface); and the memory chip is connected to the other side of the logic wafer (e.g., bottom surface).

The logic wafer has a logic circuit configured to process images from the image sensor chip, and another logic circuit configured to operate the memory cells in the memory chip to perform multiplications and accumulation operations.

The memory chip can have multiple layers of memory cells. Each memory cell can be programmed to store a bit of a binary representation of an integer weight. Each input line can be applied a voltage according to a bit of an integer. Columns of memory cells can be used to store bits of a weight matrix; and a set of input lines can be used to control voltage drivers to apply read voltages on rows of memory cells according to bits of an input vector.

The threshold voltage of a memory cell used for multiplication and accumulation operations can be programmed in a synapse mode such that the current going through the memory cell subjecting to a predetermined read voltage is either a predetermined amount representing a value of one stored in the memory cell, or negligible to represent a value of zero stored in the memory cell. When the predetermined read voltage is not applied, the current going through the memory cell is negligible regardless of the value stored in the memory cell. As a result of the configuration, the current going through the memory cell corresponds to the result of 1-bit weight, as stored in the memory cell, multiplied by 1-bit input, corresponding to the presence or the absence of the predetermined read voltage driven by a voltage driver controlled by the 1-bit input. Output currents of the memory cells, representing the results of a column of 1-bit weights stored in the memory cells and multiplied by a column of 1-bit inputs respective, are connected to a common line for summation. The summed current in the common line is a multiple of the predetermined amount; and the multiples can be digitized and determined using an analog to digital converter. Such results of 1-bit to 1-bit multiplications and accumulations can be performed for different significant bits of weights and different significant bits of inputs. The results for different significant bits can be shifted to apply the weights of the respective significant bits for summation to obtain the results of multiplications of multi-bit weights and multi-bit inputs with accumulation, as further discussed below.

Using the capability of performing multiplication and accumulation operations implemented via memory cell arrays, the logic circuit in the logic wafer can be configured to perform inference computations, such as the computation of an artificial neural network.

FIG. 4 shows an integrated circuit device 101 having an image sensing pixel array 111, a memory cell array 113, and circuits to perform inference computations according to one embodiment.

In FIG. 4, the integrated circuit device 101 has an integrated circuit die 109 having logic circuits 121 and 123, an integrated circuit die 103 having the image sensing pixel array 111, and an integrated circuit die 105 having a memory cell array 113.

The integrated circuit die 109 having logic circuits 121 and 123 can be considered a logic chip; the integrated circuit die 103 having the image sensing pixel array 111 can be considered an image sensor chip; and the integrated circuit die 105 having the memory cell array 113 can be considered a memory chip.

In FIG. 4, the integrated circuit die 105 having the memory cell array 113 further includes voltage drivers 115 and current digitizers 117. The memory cell array 113 are connected such that currents generated by the memory cells in response to voltages applied by the voltage drivers 115 are summed in the array 113 for columns of memory cells (e.g., as illustrated in FIG. 7 and FIG. 8); and the summed currents are digitized to generate the sum of bit-wise multiplications. The inference logic circuit 123 can be configured to instruct the voltage drivers 115 to apply read voltages according to a column of inputs, perform shifts and summations to generate the results of a column or matrix of weights multiplied by the column of inputs with accumulation.

The inference logic circuit 123 can be further configured to perform inference computations according to weights stored in the memory cell array 113 (e.g., the computation of an artificial neural network) and inputs derived from the image data generated by the image sensing pixel array 111. Optionally, the inference logic circuit 123 can include a programmable processor that can execute a set of instructions to control the inference computation. Alternatively, the inference computation is configured for a particular artificial neural network with certain aspects adjustable via weights stored in the memory cell array 113. Optionally, the inference logic circuit 123 is implemented via an application-specific integrated circuit (ASIC), a field-programmable gate array (FPGA), or a core of a programmable microprocessor.

In FIG. 4, the integrated circuit die 105 having the memory cell array 113 has a bottom surface 133; and the integrated circuit die 109 having the inference logic circuit 123 has a portion of a top surface 134. The two surfaces 133 and 134 can be connected via hybrid bonding to provide a portion of a direct bond interconnect 107 between the metal portions on the surfaces 133 and 134.

Similarly, the integrated circuit die 103 having the image sensing pixel array 111 has a bottom surface 131; and the integrated circuit die 109 having the inference logic circuit 123 has another portion of its top surface 132. The two surfaces 131 and 132 can be connected via hybrid bonding to provide a portion of the direct bond interconnect 107 between the metal portions on the surfaces 131 and 132.

An image sensing pixel in the array 111 can include a light sensitive element configured to generate a signal responsive to intensity of light received in the element. For example, an image sensing pixel implemented using a complementary metal-oxide-semiconductor (CMOS) technique or a charge-coupled device (CCD) technique can be used.

In some implementations, the image processing logic circuit 121 is configured to pre-process an image from the image sensing pixel array 111 to provide a processed image as an input to the inference computation controlled by the inference logic circuit 123.

Optionally, the image processing logic circuit 121 can also use the multiplication and accumulation function provided via the memory cell array 113.

In some implementations, the direct bond interconnect 107 includes wires for writing image data from the image sensing pixel array 111 to a portion of the memory cell array 113 for further processing by the image processing logic circuit 121 or the inference logic circuit 123, or for retrieval via an interface 125.

The inference logic circuit 123 can buffer the result of inference computations in a portion of the memory cell array 113.

The interface 125 of the integrated circuit device 101 can be configured to support a memory access protocol, or a storage access protocol or any combination thereof. Thus, an external device (e.g., a processor, a central processing unit) can send commands to the interface 125 to access the storage capacity provided by the memory cell array 113.

For example, the interface 125 can be configured to support a connection and communication protocol on a computer bus, such as a peripheral component interconnect express (PCIe) bus, a serial advanced technology attachment (SATA) bus, a universal serial bus (USB) bus, a compute express link, etc. In some embodiments, the interface 125 can be configured to include an interface of a solid-state drive (SSD), such as a ball grid array (BGA) SSD. In some embodiments, the interface 125 is configured to include an interface of a memory module, such as a double data rate (DDR) memory module, a dual in-line memory module, etc. The interface 125 can be configured to support a communication protocol such as a protocol according to non-volatile memory express (NVMe), non-volatile memory host controller interface specification (NVMHCIS), etc.

The integrated circuit device 101 can appear to be a memory sub-system from the point of view of a device in communication with the interface 125. Through the interface 125 an external device (e.g., a processor, a central processing unit) can access the storage capacity of the memory cell array 113. For example, the external device can store and update weight matrices and instructions for the inference logic circuit 123, retrieve images generated by the image sensing pixel array 111 and processed by the image processing logic circuit 121, and retrieve results of inference computations controlled by the inference logic circuit 123.

In some implementations, some of the circuits (e.g., voltage drivers 115, or current digitizers 117, or both) are implemented in the integrated circuit die 109 having the inference logic circuit 123, as illustrated in FIG. 5.

In FIG. 4, the image sensor chip and the memory chip are placed side by side on the same side (e.g., top side) of the logic chip. Alternatively, the image sensor chip and the memory chip can be placed on different sides (e.g., top surface and bottom surface) of the logic chip, as illustrated in FIG. 6.

FIG. 5 and FIG. 6 illustrate different configurations of integrated imaging and inference devices according to some embodiments.

Similar to the integrated circuit device 101 of FIG. 4, the device 101 in FIG. 5 and FIG. 6 can also have an integrated circuit die 109 having image processing logic circuits 121 and inference logic circuit 123, an integrated circuit die 103 having an image sensing pixel array 111, and an integrated circuit die 105 having a memory cell array 113.

However, in FIG. 5, the voltage drivers 115 and current digitizers 117 are configured in the integrated circuit die 109 having the inference logic circuit 123. Thus, the integrated circuit die 105 of the memory cell array 113 can be manufactured to contain memory cells and wire connections without added complications of voltage drivers 115 and current digitizers 117.

In FIG. 5, a direct bond interconnect 108 connects the image sensing pixel array 111 to the image processing logic circuit 121. Alternatively, microbumps can be used to connect the image sensing pixel array 111 to the image processing logic circuit 121.

In FIG. 5, another direct bond interconnect 107 connects the memory cell array 113 to the voltage drivers 115 and the current digitizers 117. Since the direct bond interconnects 107 and 108 are separate from each other, the image sensor chip may not write image data directly into the memory chip without going through the logic circuits in the logic chip. Alternatively, a direct bond interconnect 107 as illustrated in FIG. 4 can be configured to allow the image sensor chip to write image data directly into the memory chip without going through the logic circuits in the logic chip.

Optionally, some of the voltage drivers 115, the current digitizers 117, and the inference logic circuits 123 can be configured in the memory chip, while the remaining portion is configured in the logic chip.

FIG. 4 and FIG. 5 illustrate configurations where the memory chip and the image sensor chip are placed side-by-side on the logic chip. During manufacturing of the integrated circuit devices 101, memory chips and image sensor chips can be placed on a surface of a logic wafer containing the circuits of the logic chips to apply hybrid bonding. The memory chips and image sensor chips can be combined to the logic wafer at the same time. Subsequently, the logic wafer having the attached memory chips and image sensor chips can be divided into chips of the integrated circuit devices (e.g., 101).

Alternatively, as in FIG. 6, the image sensor chip and the memory chip are placed on different sides of the logic chip.

In FIG. 6, the image sensor chip is connected to the logic chip via a direct bond interconnect 108 on the top surface 132 of the logic chip. Alternatively, microbumps can be used to connect the image sensor chip to the logic chip. The memory chip is connected to the logic chip via a direct bond interconnect 107 on the bottom surface 133 of the logic chip. During the manufacturing of the integrated circuit devices 101, an image sensor wafer can be attached to, bonded to, or combined with the top surface of the logic wafer in a process/operation; and the memory wafer can be attached to, bonded to, or combined with the bottom side of the logic wafer in another process. The combined wafers can be divided into chips of the integrated circuit devices 101.

FIG. 6 illustrates a configuration in which the voltage drivers 115 and current digitizers 117 are configured in the memory chip having the memory cell array 113. Alternatively, some of the voltage drivers 115, the current digitizers 117, and the inference logic circuit 123 are configured in the memory chip, while the remaining portion is configured in the logic chip disposed between the image sensor chip and the memory chip. In other implementations, the voltage drivers 115, the current digitizers 117, and the inference logic circuit 123 are configured in the logic chip, in a way similar to the configuration illustrated in FIG. 5.

In FIG. 4, FIG. 5, and FIG. 6, the interface 125 is positioned at the bottom side of the integrated circuit device 101, while the image sensor chip is positioned at the top side of the integrated device 101 to receive incident light for generating images.

The voltage drivers 115 in FIG. 4, FIG. 5, and FIG. 6 can be controlled to apply voltages to program the threshold voltages of memory cells in the array 113. Data stored in the memory cells can be represented by the levels of the programmed threshold voltages of the memory cells.

A typical memory cell in the array 113 has a nonlinear current to voltage curve. When the threshold voltage of the memory cell is programmed to a first level to represent a stored value of one, the memory cell allows a predetermined amount of current to go through when a predetermined read voltage higher than the first level is applied to the memory cell. When the predetermined read voltage is not applied (e.g., the applied voltage is zero), the memory cell allows a negligible amount of current to go through, compared to the predetermined amount of current. On the other hand, when the threshold voltage of the memory cell is programmed to a second level higher than the predetermined read voltage to represent a stored value of zero, the memory cell allows a negligible amount of current to go through, regardless of whether the predetermined read voltage is applied. Thus, when a bit of weight is stored in the memory as discussed above, and a bit of input is used to control whether to apply the predetermined read voltage, the amount of current going through the memory cell as a multiple of the predetermined amount of current corresponds to the digital result of the stored bit of weight multiplied by the bit of input. Currents representative of the results of 1-bit by 1-bit multiplications can be summed in an analog form before digitized for shifting and summing to perform multiplication and accumulation of multi-bit weights against multi-bit inputs, as further discussed below.

FIG. 7 shows the computation of a column of weight bits multiplied by a column of input bits to provide an accumulation result according to one embodiment.

In FIG. 7, a column of memory cells 207, 217, . . . , 227 (e.g., in the memory cell array 113 of an integrated circuit device 101) can be programmed to have threshold voltages at levels representative of weights stored one bit per memory cell.

Voltage drivers 203, 213, . . . , 223 (e.g., in the voltage drivers 115 of an integrated circuit device 101) are configured to apply voltages 205, 215, . . . , 225 to the memory cells 207, 217, . . . , 227 respectively according to their received input bits 201, 211, . . . , 221.

For example, when the input bit 201 has a value of one, the voltage driver 203 applies the predetermined read voltage as the voltage 205, causing the memory cell 207 to output the predetermined amount of current as its output current 209 if the memory cell 207 has a threshold voltage programmed at a lower level, which is lower than the predetermined read voltage, to represent a stored weight of one, or to output a negligible amount of current as its output current 209 if the memory cell 207 has a threshold voltage programmed at a higher level, which is higher than the predetermined read voltage, to represent a stored weight of zero. However, when the input bit 201 has a value of zero, the voltage driver 203 applies a voltage (e.g., zero) lower than the lower level of threshold voltage as the voltage 205 (e.g., does not apply the predetermined read voltage), causing the memory cell 207 to output a negligible amount of current at its output current 209 regardless of the weight stored in the memory cell 207. Thus, the output current 209 as a multiple of the predetermined amount of current is representative of the result of the weight bit, stored in the memory cell 207, multiplied by the input bit 201.

Similarly, the current 219 going through the memory cell 217 as a multiple of the predetermined amount of current is representative of the result of the weight bit, stored in the memory cell 217, multiplied by the input bit 211; and the current 229 going through the memory cell 227 as a multiple of the predetermined amount of current is representative of the result of the weight bit, stored in the memory cell 227, multiplied by the input bit 221.

The output currents 209, 219, . . . , and 229 of the memory cells 207, 217, . . . , 227 are connected to a common line 241 for summation. The summed current 231 is compared to the unit current 232, which is equal to the predetermined amount of current, by a digitizer 233 of an analog to digital converter 245 to determine the digital result 237 of the column of weight bits, stored in the memory cells 207, 217, . . . , 227 respectively, multiplied by the column of input bits 201, 211, . . . , 221 respectively with the summation of the results of multiplications.

The sum of negligible amounts of currents from memory cells connected to the line 241 is small when compared to the unit current 232 (e.g., the predetermined amount of current). Thus, the presence of the negligible amounts of currents from memory cells does not alter the result 237 and is negligible in the operation of the analog to digital converter 245.

In FIG. 7, the voltages 205, 215, . . . , 225 applied to the memory cells 207, 217, . . . , 227 are representative of digitized input bits 201, 211, . . . , 221; the memory cells 207, 217, . . . , 227 are programmed to store digitized weight bits; and the currents 209, 219, . . . , 229 are representative of digitized results. Thus, the memory cells 207, 217, . . . , 227 do not function as mem ristors that convert analog voltages to analog currents based on their linear resistances over a voltage range; and the operating principle of the memory cells in computing the multiplication is fundamentally different from the operating principle of a memristor crossbar. When a memristor crossbar is used, conventional digital to analog converters are used to generate an input voltage proportional to inputs to be applied to the rows of memristor crossbar. When the technique of FIG. 7 is used, such digital to analog converters can be eliminated; and the operation of the digitizer 233 to generate the result 237 can be greatly simplified. The result 237 is an integer that is no larger than the count of memory cells 207, 217, . . . , 227 connected to the line 241. The digitized form of the output currents 209, 219, . . . , 229 can increase the accuracy and reliability of the computation implemented using the memory cells 207, 217, . . . , 227.

In general, a weight involving a multiplication and accumulation operation can be more than one bit. Multiple columns of memory cells can be used to store the different significant bits of weights, as illustrated in FIG. 8 to perform multiplication and accumulation operations.

The circuit illustrated in FIG. 7 can be considered a multiplier-accumulator unit configured to operate on a column of 1-bit weights and a column of 1-bit inputs. Multiple such circuits can be connected in parallel to implement a multiplier-accumulator unit to operate on a column of multi-bit weights and a column of 1-bit inputs, as illustrated in FIG. 8.

The circuit illustrated in FIG. 7 can also be used to read the data stored in the memory cells 207, 217, . . . , 227. For example, to read the data or weight stored in the memory cell 207, the input bits 211, . . . , 221 can be set to zero to cause the memory cells 217, . . . , 227 to output negligible amount of currents into the line 241 (e.g., as a bitline). The input bit 201 is set to one to cause the voltage driver 203 to apply the predetermined read voltage. Thus, the result 237 from the digitizer 233 provides the data or weight stored in the memory cell 207. Similarly, the data or weight stored in the memory cell 217 can be read via applying one as the input bit 211 and zeros as the remaining input bits in the column; and data or weight stored in the memory cell 227 can be read via applying one as the input bit 221 and zeros as the other input bits in the column.

In general, the circuit illustrated in FIG. 7 can be used to select any of the memory cells 207, 217, . . . , 227 for read or write. A voltage driver (e.g., 203) can apply a programming voltage pulse to adjust the threshold voltage of a respective memory cell (e.g., 207) to erase data, to store data or weigh, etc.

FIG. 8 shows the computation of a column of multi-bit weights multiplied by a column of input bits to provide an accumulation result according to one embodiment.

In FIG. 8, a weight 250 in a binary form has a most significant bit 257, a second most significant bit 258, . . . , a least significant bit 259. The significant bits 257, 258, . . . , 259 can be stored in memory cells 207, 206, . . . , 208 in a number of columns respectively in an array 273. The significant bits 257, 258, . . . , 259 of the weight 250 are to be multiplied by the input bit 201 represented by the voltage 205 applied on a line 281 (e.g., a wordline) by a voltage driver 203 (e.g., as in FIG. 7).

Similarly, memory cells 217, 216, . . . , 218 can be used to store the corresponding significant bits of a next weight to be multiplied by a next input bit 211 represented by the voltage 215 applied on a line 282 (e.g., a wordline) by a voltage driver 213 (e.g., as in FIG. 7); and memory cells 227, 226, . . . , 228 can be used to store corresponding of a weight to be multiplied by the input bit 221 represented by the voltage 225 applied on a line 283 (e.g., a wordline) by a voltage driver 223 (e.g., as in FIG. 7).

The most significant bits (e.g., 257) of the weights (e.g., 250) stored in the respective rows of memory cells in the array 273 are multiplied by the input bits 201, 211, . . . , 221 represented by the voltages 205, 215, . . . , 225 and then summed as the current 231 in a line 241 and digitized using a digitizer 233, as in FIG. 7, to generate a result 237 corresponding to the most significant bits of the weights.

Similarly, the second most significant bits (e.g., 258) of the weights (e.g., 250) stored in the respective rows of memory cells in the array 273 are multiplied by the input bits 201, 211, . . . , 221 represented by the voltages 205, 215, . . . , 225 and then summed as a current in a line 242 and digitized to generate a result 236 corresponding to the second most significant bits.

Similarly, the least most significant bits (e.g., 259) of the weights (e.g., 250) stored in the respective rows of memory cells in the array 273 are multiplied by the input bits 201, 211, . . . , 221 represented by the voltages 205, 215, . . . , 225 and then summed as a current in a line 243 and digitized to generate a result 238 corresponding to the least significant bit.

The most significant bit can be left shifted by one bit to have the same weight as the second significant bit, which can be further left shifted by one bit to have the same weight as the next significant bit. Thus, the result 237 generated from multiplication and summation of the most significant bits (e.g., 257) of the weights (e.g., 250) can be applied an operation of left shift 247 by one bit; and the operation of add 246 can be applied to the result of the operation of left shift 247 and the result 236 generated from multiplication and summation of the second most significant bits (e.g., 258) of the weights (e.g., 250). The operations of left shift (e.g., 247, 249) can be used to apply weights of the bits (e.g., 257, 258, . . . ) for summation using the operations of add (e.g., 246, . . . , 248) to generate a result 251. Thus, the result 251 is equal to the column of weights in the array 273 of memory cells multiplied by the column of input bits 201, 211, . . . , 221 with multiplication results accumulated.

In general, an input involving a multiplication and accumulation operation can be more than 1 bit. Columns of input bits can be applied one column at a time to the weights stored in the array 273 of memory cells to obtain the result of a column of weights multiplied by a column of inputs with results accumulated as illustrated in FIG. 9.

The circuit illustrated in FIG. 8 can be used to read the data stored in the array 273 of memory cells. For example, to read the data or weight 250 stored in the memory cells 207, 206, . . . , 208, the input bits 211, . . . , 221 can be set to zero to cause the memory cells 217, 216, . . . , 218, . . . , 227, 226, . . . , 228 to output negligible amount of currents into the line 241, 242, . . . , 243 (e.g., as bitlines). The input bit 201 is set to one to cause the voltage driver 203 to apply the predetermined read voltage as the voltage 205. Thus, the results 237, 236, . . . , 238 from the digitizers (e.g., 233) connected to the lines 241, 242, . . . , 243 provide the bits 257, 258, . . . , 259 of the data or weight 250 stored in the row of memory cells 207, 206, . . . , 208. Further, the result 251 computed from the operations of shift 247, 249, . . . and operations of add 246, . . . , 248 provides the weight 250 in a binary form.

In general, the circuit illustrated in FIG. 8 can be used to select any row of the memory cell array 273 for read. Optionally, different columns of the memory cell array 273 can be driven by different voltage drivers. Thus, the memory cells (e.g., 207, 206, . . . , 208) in a row can be programmed to write data in parallel (e.g., to store the bits 257, 258, . . . , 259) of the weight 250.

FIG. 9 shows the computation of a column of multi-bit weights multiplied by a column of multi-bit inputs to provide an accumulation result according to one embodiment.

In FIG. 9, the significant bits of inputs (e.g., 280) are applied to a multiplier-accumulator unit 270 at a plurality of time instances T, T1, . . . , T2.

For example, a multi-bit input 280 can have a most significant bit 201, a second most significant bit 202, . . . , a least significant bit 204.

At time T, the most significant bits 201, 211, . . . , 221 of the inputs (e.g., 280) are applied to the multiplier-accumulator unit 270 to obtain a result 251 of weights (e.g., 250), stored in the memory cell array 273, multiplied by the column of bits 201, 211, . . . , 221 with summation of the multiplication results.

For example, the multiplier-accumulator unit 270 can be implemented in a way as illustrated in FIG. 8. The multiplier-accumulator unit 270 has voltage drivers 271 connected to apply voltages 205, 215, . . . , 225 representative of the input bits 201, 211, . . . , 221. The multiplier-accumulator unit 270 has a memory cell array 273 storing bits of weights as in FIG. 8. The multiplier-accumulator unit 270 has digitizers 275 to convert currents summed on lines 241, 242, . . . , 243 for columns of memory cells in the array 273 to output results 237, 236, . . . , 238. The multiplier-accumulator unit 270 has shifters 277 and adders 279 connected to combine the column result 237, 236, . . . , 238 to provide a result 251 as in FIG. 8.

Similarly, at time T1, the second most significant bits 202, 212, . . . , 222 of the inputs (e.g., 280) are applied to the multiplier-accumulator unit 270 to obtain a result 253 of weights (e.g., 250) stored in the memory cell array 273 and multiplied by the vector of bits 202, 212, . . . , 222 with summation of the multiplication results.

Similarly, at time T2, the least significant bits 204, 214, . . . , 224 of the inputs (e.g., 280) are applied to the multiplier-accumulator unit 270 to obtain a result 255 of weights (e.g., 250), stored in the memory cell array 273, multiplied by the vector of bits 202, 212, . . . , 222 with summation of the multiplication results.

The result 251 generated from multiplication and summation of the most significant bits 201, 211, . . . , 221 of the inputs (e.g., 280) can be applied an operation of left shift 261 by one bit; and the operation of add 262 can be applied to the result of the operation of left shift 261 and the result 253 generated from multiplication and summation of the second most significant bits 202, 212, . . . , 222 of the inputs (e.g., 280). The operations of left shift (e.g., 261, 263) can be used to apply weights of the bits (e.g., 201, 202, . . . ) for summation using the operations of add (e.g., 262, . . . , 264) to generate a result 267. Thus, the result 267 is equal to the weights (e.g., 250) in the array 273 of memory cells multiplied by the column of inputs (e.g., 280) respectively and then summed.

A plurality of multiplier-accumulator unit 270 can be connected in parallel to operate on a matrix of weights multiplied by a column of multi-bit inputs over a series of time instances T, T1, . . . , T2.

The multiplier-accumulator units (e.g., 270) illustrated in FIG. 7, FIG. 8, and FIG. 9 can be implemented in integrated circuit devices 101 in FIG. 4, FIG. 5, and FIG. 6.

In some implementations, the memory cell array 113 in the integrated circuit devices 101 in FIG. 4, FIG. 5, and FIG. 6 has multiple layers of memory cell arrays.

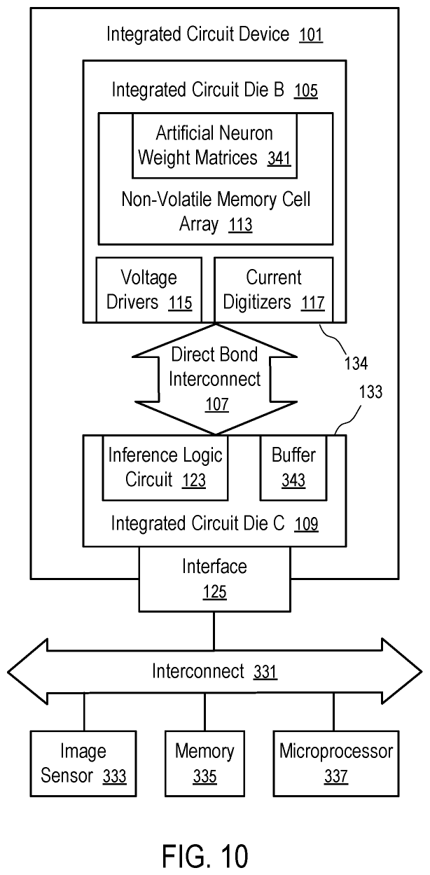

FIG. 10 shows a computing system configured to process an image using an integrated circuit device and an artificial neural network according to one embodiment.

In FIG. 10, an integrated circuit device 101 has a memory chip (e.g., integrated circuit die 105) and a logic chip (e.g., integrated circuit die 109) with variations similar to the integrated circuit devices 101 of FIG. 4, FIG. 5, and FIG. 6. Optionally, the integrated circuit device 101 of FIG. 10 can have an image chip (e.g., integrated circuit die 103) as in FIG. 4, FIG. 5, or FIG. 6. Alternatively, the integrated circuit device 101 of FIG. 10 can be manufactured to have no image chip.

In FIG. 10, the interface 125 of the integrated circuit device 101 can receive commands to write an image into the integrated circuit device 101 as a memory device, or a storage device, or both.

For example, the image sensor 333 can write an image through the interconnect 331 (e.g., one or more computer buses) into the interface 125. Alternatively, a microprocessor 337 can function as a host system to retrieve an image from the image sensor 333, optionally buffer the image in the memory 335, and write the image to the interface 125. The interface 125 can place the image data in the buffer 343 as an input to the inference logic circuit 123.

In some implementations, when the integrated circuit device 101 has an image sensing pixel array 111 (e.g., as in FIG. 4, FIG. 5, and FIG. 6), the image chip or the image processing logic circuit 121 can send image data to the buffer 343 directly, or through the interface 125.

In response to the image data in the buffer 343, the inference logic circuit 123 can generate a column of inputs. The memory cell array 113 in the memory chip (e.g., integrated circuit die 105) can store an artificial neuron weight matrix 341 configured to weigh on the inputs to an artificial neural network. The inference logic circuit 123 can instruct the voltage drivers 115 to apply a column of significant bits of the inputs a time to an array of memory cells storing the artificial neuron weight matrix 341 to obtain a column of results (e.g., 251) using the technique of FIG. 8 and FIG. 9. The inference logic circuit 123 can transform the column of results (e.g., according to activation functions of artificial neurons) to generate a next column of inputs to be further weighted on using a further artificial neuron weight matrix 341. The process can continue until a last artificial neuron weight matrix 341 is applied to produce the output of the artificial neural network.

The inference logic circuit 123 can be configured to place the output of the artificial neural network into the buffer 343 for retrieval as a response to, or replacement of, the image written to the interface 125. Optionally, the inference logic circuit 123 can be configured to write the output of the artificial neural network into the memory cell array 113 in the memory chip. In some implementations, an external device (e.g., the image sensor, the microprocessor 337) writes an image into the interface 125; and in response to the integrated circuit device 101 generates the output of the artificial neural network in response to the image and write the output as a replacement of the image into the memory chip.

The memory cells in the memory cell array 113 can be non-volatile. Thus, once the weight matrices 341 are written into the memory cell array 113, the integrated circuit device 101 has the computation capability of the artificial neural network without further configuration or assistance from an external device (e.g., a host system). The computation capability can be used immediately upon supplying power to the integrated circuit device 101 without the need to boot up and configure the integrated circuit device 101 by a host system (e.g., microprocessor 337 running an operating system). The power to the integrated circuit device 101 (or a portion of it) can be turned off when the integrated circuit device 101 is not used in computing an output of an artificial neural network, and not used in reading or write data to the memory chip. Thus, the energy consumption of the computing system can be reduced.

In some implementations, the inference logic circuit 123 is programmable to perform operations of forming columns of inputs, applying the weights stored in the memory chip, and transforming columns of data (e.g., according to activation functions of artificial neurons). The instructions can also be stored in the non-volatile memory cell array 113 in the memory chip.

In some implementations, the inference logic circuit 123 includes an array of identical logic circuits configured to perform the computation of some types of activation functions, such as step activation function, rectified linear unit(ReLU) activation function, heaviside activation function, logistic activation function, gaussian activation function, multiquadratics activation function, inverse multiquadratics activation function, polyharmonic splines activation function, folding activation functions, ridge activation functions, radial activation functions, etc.

In some implementations, the multiplication and accumulation operations in an activation function are performed using multiplier-accumulator units 270 implemented using memory cells in the array 113.

Some activation functions can be implemented via multiplication and accumulation operations with fixed weights.

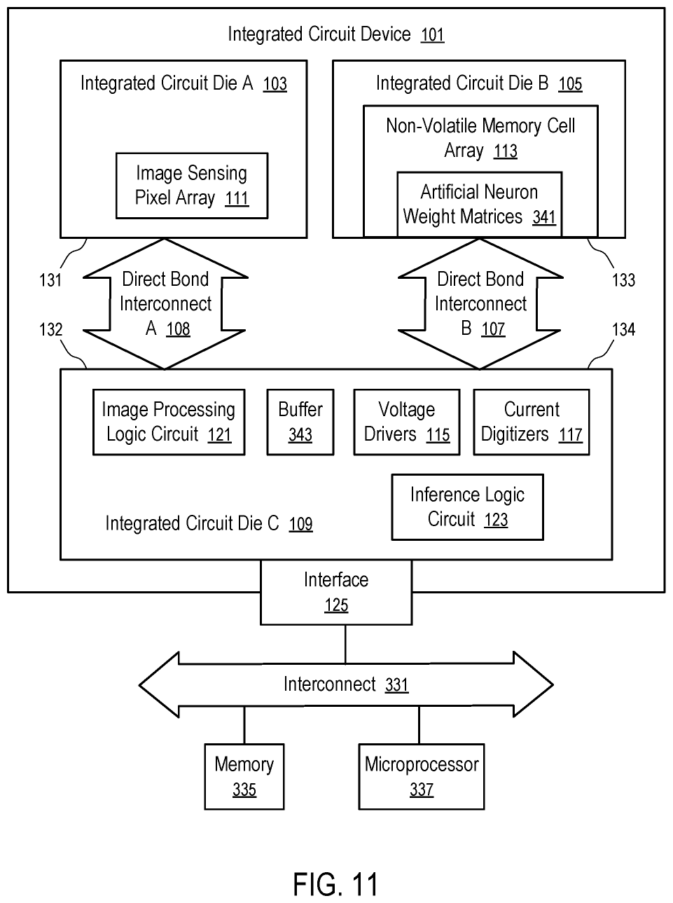

FIG. 11 shows another computing system according to one embodiment.

The integrated circuit device 101 in FIG. 11 has an integrated circuit die 109 with an inference logic circuit 123 and a non-volatile memory cell array 113 as in FIG. 10.

In FIG. 11, the voltage drivers 115 and the current digitizers 117 are configured in the logic chip (e.g., integrated circuit die 109 having the inference logic circuit 123). Alternatively, at least a portion of the voltage drivers 115 and the current digitizers 117 can be implemented in the memory chip (e.g., integrated circuit die 105 having the memory cell array 113).

In FIG. 11, the integrated circuit device 101 includes an image chip (e.g., integrated circuit die 103 having image sensing pixel array 111).

An image processing logic circuit 121 in the logic chip can pre-process an image from the image sensing pixel array 111 as an input to the inference logic circuit 123. After the image processing logic circuit 121 stores the input into the buffer 343, the inference logic circuit 123 can perform the computation of an artificial neural network in a way similar to the integrated circuit device 101 of FIG. 10.

For example, the inference logic circuit 123 can store the output of the artificial neural network into the memory chip in response to the input in the buffer 343.

Optionally, the image processing logic circuit 121 can also store one or more versions of the image captured by the image sensing pixel array 111 in the memory chip as a solid-state drive.

An application running in the microprocessor 337 can send a command to the interface 125 to read at a memory address in the memory chip. In response, the image sensing pixel array 111 can capture an image; the image processing logic circuit 121 can process the image to generate an input in the buffer; and the inference logic circuit 123 can generate an output of the artificial neural network responding to the input. The integrated circuit device 101 can provide the output as the content retrieved at the memory address; and the application running in the microprocessor 337 can determine, based on the output, whether to read further memory addresses to retrieve the image or the input generated by the image processing logic circuit 121. For example, the artificial neural network can be trained to generate a classification of whether the image captures an object of interest and if so, a bounding box of a portion of the image containing the image of the object and a classification of the object. Based on the output of the artificial neural network, the application running in the microprocessor 337 can decide whether to retrieve the image, or the image of the object in the bounding box, or both.

In some implementations, the original image, or the input generated by the image processing logic circuit 121, or both can be placed in the buffer 343 for retrieval by the microprocessor 337. If the microprocessor 337 decides not to retrieve the image data in view of the output of the artificial neural network, the image data in the buffer 343 can be discarded when the microprocessor 337 sends a command to the interface 125 to read a next image.

Optionally, the buffer 343 is configured with sufficient capacity to store data for up to a predetermined number of images. When the buffer 343 is full, the oldest image data in the buffer is erased.

When the integrated circuit device 101 is not in an active operation (e.g., capturing an image, operating the interface 125, or performing the artificial neural network computations), the integrated circuit device 101 can automatically enter a low power mode to avoid or reduce power consumption. A command to the interface 125 can wake up the integrated circuit device 101 to process the command.

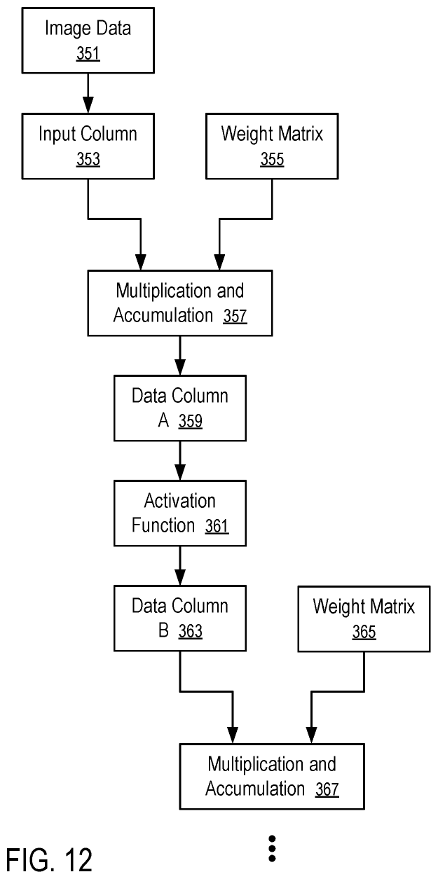

FIG. 12 shows an implementation of artificial neural network computations according to one embodiment. For example, the computations of FIG. 12 can be implemented in the integrated circuit devices 101 of FIG. 4, FIG. 5, FIG. 6, FIG. 10, and FIG. 11.

In FIG. 12, image data 351 can be provided as an input to an artificial neural network from an image sensing pixel array 111, an image processing logic circuit 121, an image sensor 333, or a microprocessor 337.

An inference logic circuit 123 in an integrated circuit device 101 can arrange the pixel values from the image data 351 into a column 353 of inputs.

A weight matrix 355 is stored in one or more layers of the memory cell array 113 in the memory chip of the integrated circuit device 101.

A multiplication and accumulation 357 combined the input columns 353 and the weight matrix 355. For example, the inference logic circuit 123 identifies the storage location of the weight matrix 355 in the memory chip, instructs the voltage drivers 115 to apply, according to the bits of the input column, voltages to memory cells storing the weights in the matrix 355, and retrieve the multiplication and accumulation results (e.g., 267) from the logic circuits (e.g., adder 264) of the multiplier-accumulator units 270 containing the memory cells.

The multiplication and accumulation results (e.g., 267) provide a column 359 of data representative of combined inputs to a set of input artificial neurons of the artificial neural network. The inference logic circuit 123 can use an activation function 361 to transform the data column 359 to a column 363 of data representative of outputs from the next set of artificial neurons. The outputs from the set of artificial neurons can be provided as inputs to a next set of artificial neurons. A weight matrix 365 includes weights applied to the outputs of the neurons as inputs to the next set of artificial neurons and biases for the neurons. A multiplication and accumulation 367 can be performed in a similar way as the multiplication and accumulation 357. Such operations can be repeated from multiple set of artificial neurons to generate an output of the artificial neural network.

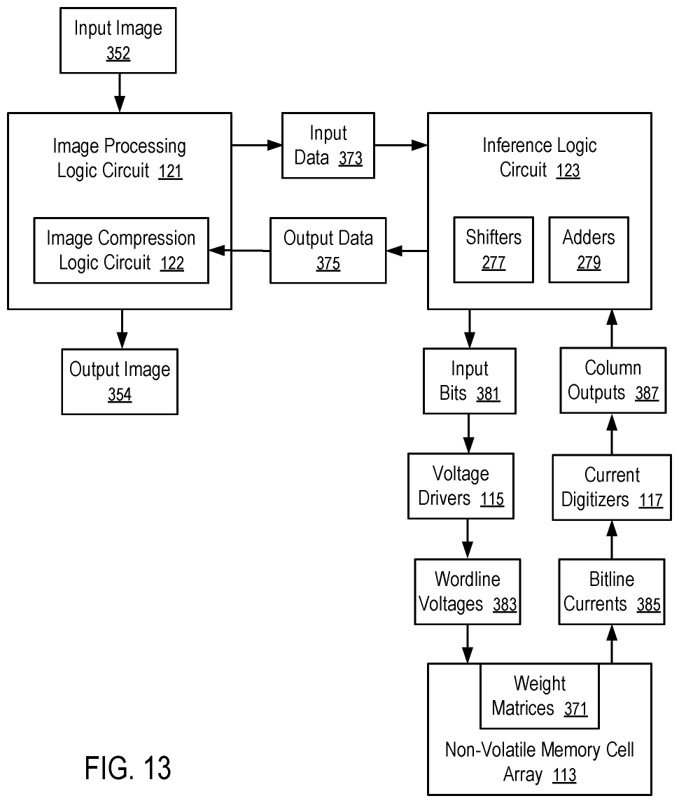

FIG. 13 shows an image processing logic circuit using an inference logic circuit in image compression according to one embodiment. For example, the technique of FIG. 13 can be implemented in integrated circuit devices 101 of FIG. 4, FIG. 5, FIG. 6, FIG. 10, and FIG. 11.

In FIG. 13, an image processing logic circuit 121 in a logic chip (e.g., integrated circuit die 109) in an integrated circuit device 101 is configured to compress an input image 352 to generate an output image 354. The image compression can include lossy compression, lossless compression, image trimming, etc.

The image compression computation can include, or formulated to include, multiplication and accumulation operations based on weight matrices 371 stored in a memory chip (e.g., integrated circuit die 105) in the integrated circuit devices 101. Preferably, the weight matrices 371 do not change for typical image compression such that the weight matrices 371 can be written into the non-volatile memory cell array 113 without repeatedly erasing and programming so that the useful life of the non-volatile memory cell array 113 can be extended. Some types of non-volatile memory cells (e.g., cross point memory) can have a high budget for erasing and programming. When the memory cells in the array 113 can tolerate a high number of erasing and programming cycles, the image compression computation can also be formulated to use weight matrices 371 that change during the computations of image compression.

The image processing logic circuit 121 can include an image compression logic circuit 122 configured to generate input data 373 for the inference logic circuit 123 to apply operations of multiplication and accumulation on weight matrices 371 to generate output data 375. The input data 373 can include, for example, pixel values of the input image 352, an identification/address of a weight matrix 371 stored in the memory cell array 113, or other data derived from the pixel values, or any combination thereof. After the operations of the multiplication and accumulation, the image processing logic circuit 121 can use the output data 375 received from the inference logic circuit 123 in compressing the input image 352 into the output image 354.

The input data 373 identifies a matrix 371 stored in the memory cell array 113 and a column of inputs (e.g., 280). In response, the inference logic circuit 123 uses a column of input bits 381 to control voltage drivers 115 to apply wordline voltages 383 onto rows of memory cells storing the weights of a matrix 371 identified by the input data 373. The voltage drivers 115 apply voltages of predetermined magnitudes on wordlines to represent the input bits 381. The memory cells in the memory cell array 113 are configured to output currents that are negligible or multiples of a predetermined amount of current 232. Thus, the combination of the voltage drivers 115 and the memory cells storing the weight matrices 371 functions as digital to analog converters configured to convert the results of bits of weights (e.g., 250) multiplied by the bits of inputs (e.g., 280) into output currents (e.g., 209, 219, . . . , 229). Bitlines (e.g., lines 241, 242, . . . , 243) in the memory cell array 113 sum the currents in an analog form. The summed currents (e.g., 231) in the bitlines (e.g., line 241) are digitized as column outputs 387 by the current digitizers 117 for further processing in a digital form (e.g., using shifters 277 and adders 279 in the inference logic circuit 123) to obtain the output data 375.

As illustrated in FIG. 7 and FIG. 8, the wordline voltages 383 (e.g., 205, 215, . . . , 225) are representative of the applied input bits 381 (e.g., 201, 211, . . . , 221) and cause the memory cells in the array 113 to generate output currents (e.g., 209, 21, . . . , 229). The memory cell array 113 connects output currents from each column of memory cells to a respective line (e.g., 241, 242, . . . , or 243) to sum the output currents for a respective column. Current digitizers 117 can determine the bitline currents 385 in the lines (e.g., bitlines) in the array 113 as multiples of a predetermined amount of current 232 to provide the summation results (e.g., 237, 236, . . . , 238) as the column outputs 387. Shifters 277 and adders 279 of the inference logic circuit 123 (or in the memory chip) can be used to combine the column outputs 387 with corresponding weights for different significant bits of weights (e.g., 250) as in FIG. 8 and with corresponding weights (e.g., 250) for the different significant bits of the inputs (e.g., 280) as in FIG. 9 to generate results of multiplication and accumulation.

The inference logic circuit 123 can provide the results of multiplication and accumulation as the output data 375. In response, the image compression logic circuit 122 can provide further input data 373 to obtain further output data 375 by combining the input data 373 with a weight matrix 371 in the memory cell array 113 through operations of multiplication and accumulation. Based on output data 375 generated by the inference logic circuit 123, the image compression logic circuit 122 converts the input image 352 into the output image 354.

For example, the input data 373 can be the pixel values of the input image 352 and an offset; and the weight matrix 371 can be applied to scale the pixel values and apply the offset.

For example, the input data 373 can be the pixel values of the input image 352; and the weight matrix 371 can be configured to compute transform coefficients of predetermined functions (e.g., cosine functions) having a sum representative of the pixel values, such as coefficients of discrete cosine transform of a spatial distribution of the pixel values. For example, the image compression logic circuit 122 can be configured to perform the computations of color space transformation, request the inference logic circuit 123 to compute the coefficients for discrete cosine transform (DCT), perform quantization of the DCT coefficients, and encode the results of quantization to generate the output image 354 (e.g., in a joint photographic experts group (JPEG or JPG) format).

For example, the input data 373 can be the pixel values of the input image 352; and the computation of an artificial neural network having the weight matrices 371 can be performed by the inference logic circuit 123 to identify one or more segments of the input image 352 containing content of interest. The image compression logic circuit 122 can adjust compression ratios for different segments of input image 352 to preserve more details in segments of interest and to compress more aggressively in other segments. Optionally, regions outside of the segments of interest can be deleted.

For example, an artificial neural network can be trained to rank the levels of interest in different segments of the input image 352. After the inference logic circuit 123 identifies the levels of interest in the output data 375 based on the computation of the artificial neural network responsive to the pixel values of the input image 352, the image compression logic circuit 122 can adjust compression ratios for different segments according to the ranked levels of interest of the segments. Optionally, the artificial neural network can be trained to predict the desired compression ratios of different segments of the input image 352.

In some implementations, a compression technique formulated using an artificial neural network is used. The output data 375 includes data representative of a compressed image; and the image compression logic circuit 122 can encode the output data 375 to provide the output image 354 according to a predetermined format.

Image enhancements and image analytics can be performed in a way similar to the image compression of FIG. 13.

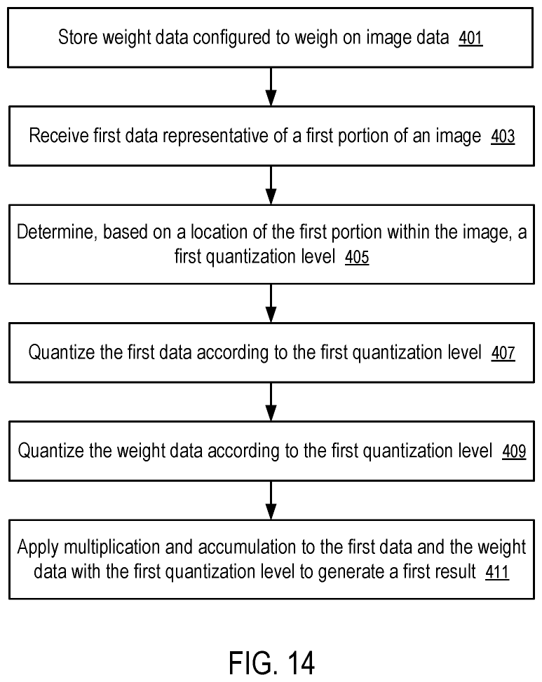

FIG. 14 shows a method of image processing according to one embodiment. For example, the method of FIG. 14 can be performed in a pair augmented reality (AR) glasses 51 of FIG. 3 implemented using an integrated circuit device 101 of FIG. 4, FIG. 5, FIG. 6, FIG. 10, or FIG. 11 using the quantization techniques of FIG. 1 and FIG. 2, and using the multiplication and accumulation techniques of FIG. 7, FIG. 8, and FIG. 9.

At block 401, a memory cell array 113 is programmed to store weight data 30 configured to weigh on image data (e.g., 19).

For example, the augmented reality (AR) glasses 51 can be implemented at least in part using an integrated circuit device 101 having a memory cell array 113 on a memory chip (e.g., integrated circuit die 105) and an inference logic circuit 123 on a logic chip (e.g., integrated circuit die 109). Optionally, the integrated circuit device 101 can further include an image sensing pixel array 111 on an image sensor chip (e.g., integrated circuit die 103) for the digital camera 53. An integrated circuit package can be configured to enclose the logic chip, the memory chip, and the image sensor chip.

The integrated circuit device 101 can have voltage drivers 115 to program and read the memory cells in the array 113 and current digitizers 117 to convert summed currents in bitlines (e.g., 241, 242, . . . , 243) as multiples of a predetermined amount of current 232.

For example, each respective memory cell in the array 113 can be programmable in a first mode (e.g., synapse mode) to support multiplication and accumulation as in FIG. 7, or in a second mode (e.g., storage mode) for improved performances in data storage and retrieval without support for multiplication and accumulation.

For example, each respective memory cell in the memory cell array 113 is: programmable in the synapse mode to output the predetermined amount of current 232 in response to a predetermined read voltage when the respective memory cell has a threshold voltage programmed to represent a value of one, or a negligible amount of current in response to the predetermined read voltage when the threshold voltage is programmed to represent a value of zero; and programmable in the storage mode to have a threshold voltage positioned in one of a plurality of voltage regions, each representative of one of a plurality of predetermined values.

To perform an operation of multiplication and accumulation, the integrated circuit device 101 can convert, using the voltage drivers 115 connected to the wordlines (e.g., 281, 282, . . . , 283) and into output currents (e.g., 209, 219, . . . , 229) of the third memory cells summed in the bitlines (e.g., 241, 242, . . . , 243), results of bitwise multiplications of bits in an input (e.g., bits 201, 211, . . . , 221; 381) and bits (e.g., 257, 258, . . . , 259; bits in weight matrices 371) stored in the third memory cells. The integrated circuit device 101 can digitize, using the current digitizers (e.g., 233, 117) connected to the bitlines (e.g., 241, 242, . . . , 243), currents (e.g., 231) in the bitlines to obtain column outputs (e.g., 237, 236, . . . , 238; 387). Using the column outputs (e.g., 387) the integrated circuit device 101 can generate results of an operation of multiplication and accumulation applied to the input and the weight matrices (e.g., 97, 341) stored in the third memory cells (e.g., in array 273).

The digital camera 53 of the augmented reality (AR) glasses 51 can capture an image 10 of a field of view as seen through the glasses 51. The processing device 55 of the augmented reality (AR) glasses 51 can be configured to perform an analysis of the image 10 using an artificial neural network having weight data (e.g., 19; weight matrices 341). For example, the artificial neural network can be trained to perform object detection, extraction, classification, identification, or recognition; and the augmented reality (AR) glasses 51 present, based on an output of the artificial neural network responsive to the image 10, content (e.g., virtual reality content 65 or text information about the recognized objects) superimposed on the view as seen by eyes (e.g., 67) of a user through the pair of augmented reality glasses 51.

The processing device 55 of the glasses 51 can be configured to apply different quantization levels (e.g., 21, 23, 25, 27) to respective data from different regions (e.g., 11, 13, 15, 17) of the image 10, and simultaneously apply the different quantization levels (e.g., 21, 23, 25, 27) to the weight data 30 in weighing on the respective data from the different regions (e.g., 11, 13, 15, 17) respectively. Thus, the quantized input data 49 and the quantized weight data 39 used to weigh on the quantized input data 49 have the same level of accuracy through quantization 41 and 42.

The different quantization levels (e.g., 21, 23, 25, 27) can be applied to respective data from different regions (e.g., 11, 13, 15, 17) of the same image 10 for analyses using the artificial neural network. To emulate the perception or vision characteristics of human ocular focus, the accuracy can decrease from a center region 11 to a peripheral region 17. Optionally, different quantization levels can be used for a same region (e.g., center region 11) for different images.

At block 403, the processing device 55 receives a first data (e.g., 19) representative of the first portion of an image 10.

At block 405, the processing device 55 determines, based on a location of the first portion within the image, a first quantization level (e.g., 29).

At block 407, the processing device 55 quantizes the first data (e.g., 19) according to the first quantization level (e.g., 29).

At block 409, the processing device 55 quantizes the weight data (e.g., 30) according to the first quantization level (e.g., 29).

At block 411, the processing device 55 applies multiplication and accumulation (e.g., using a multiplier-accumulator unit 45 or 270) to the first data (e.g., 19) and the weight data (e.g., 30) with the first quantization level (e.g., 29) to generate a first result (e.g., 47).

For example, the first result can be applied as a data column (e.g., 359) of input to one or more activation functions (e.g., 361) of a set of artificial neurons in the artificial neural network.

For example, the first quantization level (e.g., 29) can be configured to identify a first predetermined number of least significant bits for exclusion in computation.

The inference logic circuit 123 can be configured to apply the first quantization level (e.g., 29) in the multiplier-accumulator unit 45 or 270 for the first data (e.g., 19) through skipping reading the memory cells (e.g., 207, 217, . . . , 227; 206, 216, . . . , 226; . . . , 208, 218, . . . , 228) in the array (e.g., 273) storing the weight data (e.g., 30) according to least significant bits (e.g., 204), of the first predetermined number identified by the first quantization level (e.g., 29), in the first data (e.g., 19) from the first portion (e.g., region 11, 13, 15, or 17). Zeros can be used as the results (e.g., 255) for multiplication and accumulation on the least significant bits (e.g., 204), of the first predetermined number identified by the first quantization level (e.g., 29), in the first data (e.g., 19) from the first portion (e.g., region 11, 13, 15, or 17).

Further, the inference logic circuit 123 can be configured to apply the first quantization level (e.g., 29) in the multiplier-accumulator unit 45 or 270 for the weight data (e.g., 30) through reading, using voltage drivers (e.g., 115), one or more columns of the first memory cells (e.g., 207, 217, . . . , 227) storing most significant bits (e.g., 257) without reading one or more columns of the first memory cells (e.g., 208, 218, . . . , 228) storing least significant bits (e.g., 259), of the first predetermined number identified by the first quantization level (e.g., 29) in the weight data (e.g., 30) to be applied to the first data (e.g., 19).

For example, the integrated circuit device 101 can have different sets of voltage drivers to apply voltages (e.g., 205, 215, . . . , 225) to different columns of memory cells. When the computation for the least significant bit (e.g., 259) stored in the column of memory cells (e.g., 208, 218, . . . , 228) are to be excluded for a quantization level, the set of voltage driver connected to the column of memory cells (e.g., 208, 218, . . . , 228) can be instructed to apply a low voltage that causes the column of memory cells (e.g., 208, 218, . . . , 228) to output negligible currents into the bitline 243, which reduces the energy consumption associated with the reading of the column of memory cells (e.g., 208, 218, . . . , 228). Alternatively, a set of switches can be used to selectively connect the column of memory cells (e.g., 208, 218, . . . , 228) to the wordlines (e.g., 281, 282, . . . , 283) based on whether to exclude or include the bits stored in the column of memory cells (e.g., 208, 218, . . . , 228) in the multiplication and accumulation.

For example, when the processing device 55 receives second data (e.g., 19) representative of a second portion of the image 10, the processing device 55 can determine, based on a location of the second portion within the image, a second quantization level different from the first quantization level.

For example, when the first portion is in the center region 11 (or a region 13 closer to the center region 11) and the second portion is in the peripheral region 17 (or a region 15 farther away from the center region 11 than the first portion), the second quantization level can use a lower accuracy level than first quantization level.

For example, the augmented reality glasses 51 can track or determine direction of gaze of the eyes (e.g., 67) of the user and thus, in the image, a center of focus of a user. When the location of the first portion is closer to the center of focus in the image than the location of the second portion, the first quantization level can be more accurate than the second quantization level.

For example, the first quantization level (e.g., 29) can be configured to identify the first predetermined number of least significant bits for exclusion in computation; and the first quantization level (e.g., 29) can be configured to identify a second predetermined number of least significant bits, more than the first predetermined number, for exclusion in computation.

The processing device 55 can quantize the second data according to the second quantization level, quantize the weight data (e.g., 30) according to the second quantization level (e.g., 29), and apply multiplication and accumulation (e.g., using the multiplier-accumulator unit 45 or 270) to the second data and the weight data (e.g., 30) with the second quantization level (e.g., 29) to generate a second result.

Integrated circuit devices 101 (e.g., as in FIG. 4, FIG. 5, FIG. 6, FIG. 10, and FIG. 11) can be configured as a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The integrated circuit devices 101 (e.g., as in FIG. 4, FIG. 5, FIG. 6, FIG. 10, and FIG. 11) can be installed in a computing system as a memory sub-system having an embedded image sensor and an inference computation capability. Such a computing system can be a computing device such as a desktop computer, a laptop computer, a network server, a mobile device, a portion of a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

In general, a computing system can include a host system that is coupled to one or more memory sub-systems (e.g., integrated circuit device 101 of FIG. 4, FIG. 5, FIG. 6, FIG. 10, and FIG. 11). In one example, a host system is coupled to one memory sub-system. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system can include a processor chipset (e.g., processing device) and a software stack executed by the processor chipset. The processor chipset can include one or more cores, one or more caches, a memory controller (e.g., NVDIMM controller), and a storage protocol controller (e.g., PCIe controller, SATA controller). The host system uses the memory sub-system, for example, to write data to the memory sub-system and read data from the memory sub-system.

The host system can be coupled to the memory sub-system via a physical host interface. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface can be used to transmit data between the host system and the memory sub-system. The host system can further utilize an NVM express (NVMe) interface to access components (e.g., memory devices) when the memory sub-system is coupled with the host system by the PCIe interface. The physical host interface can provide an interface for passing control, address, data, and other signals between the memory sub-system and the host system. In general, the host system can access multiple memory sub-systems via a same communication connection, multiple separate communication connections, or a combination of communication connections.

The processing device of the host system can be, for example, a microprocessor, a central processing unit (CPU), a processing core of a processor, an execution unit, etc. In some instances, the controller can be referred to as a memory controller, a memory management unit, or an initiator. In one example, the controller controls the communications over a bus coupled between the host system and the memory sub-system. In general, the controller can send commands or requests to the memory sub-system for desired access to memory devices. The controller can further include interface circuitry to communicate with the memory sub-system. The interface circuitry can convert responses received from the memory sub-system into information for the host system.

The controller of the host system can communicate with the controller of the memory sub-system to perform operations such as reading data, writing data, or erasing data at the memory devices, and other such operations. In some instances, the controller is integrated within the same package of the processing device. In other instances, the controller is separate from the package of the processing device. The controller or the processing device can include hardware such as one or more integrated circuits (ICs), discrete components, a buffer memory, or a cache memory, or a combination thereof. The controller or the processing device can be a microcontroller, special-purpose logic circuitry (e.g., a field programmable gate array (FPGA), an application specific integrated circuit (ASIC), etc.), or another suitable processor.

The memory devices can include any combination of the different types of non-volatile memory components and volatile memory components. The volatile memory devices can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, or a PLC portion of memory cells, or any combination thereof. The memory cells of the memory devices can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller (or controller for simplicity) can communicate with the memory devices to perform operations such as reading data, writing data, or erasing data at the memory devices and other such operations (e.g., in response to commands scheduled on a command bus by controller). The controller can include hardware such as one or more integrated circuits (ICs), discrete components, or a buffer memory, or a combination thereof. The hardware can include digital circuitry with dedicated (i.e., hard-coded) logic to perform the operations described herein. The controller can be a microcontroller, special-purpose logic circuitry (e.g., a field programmable gate array (FPGA), an application specific integrated circuit (ASIC), etc.), or another suitable processor.

The controller can include a processing device (processor) configured to execute instructions stored in a local memory. In the illustrated example, the local memory of the controller includes an embedded memory configured to store instructions for performing various processes, operations, logic flows, and routines that control operation of the memory sub-system, including handling communications between the memory sub-system and the host system.

In some embodiments, the local memory can include memory registers storing memory pointers, fetched data, etc. The local memory can also include read-only memory (ROM) for storing micro-code. While the example memory sub-system includes a controller, in another embodiment of the present disclosure, a memory sub-system does not include a controller, and can instead rely upon external control (e.g., provided by an external host, or by a processor or controller separate from the memory sub-system).

In general, the controller can receive commands or operations from the host system and can convert the commands or operations into instructions or appropriate commands to achieve the desired access to the memory devices. The controller can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices. The controller can further include host interface circuitry to communicate with the host system via the physical host interface. The host interface circuitry can convert the commands received from the host system into command instructions to access the memory devices as well as convert responses associated with the memory devices into information for the host system.

The memory sub-system can also include additional circuitry or components that are not illustrated. In some embodiments, the memory sub-system can include a cache or buffer (e.g., DRAM) and address circuitry (e.g., a row decoder and a column decoder) that can receive an address from the controller and decode the address to access the memory devices.

In some embodiments, the memory devices include local media controllers that operate in conjunction with the memory sub-system controller to execute operations on one or more memory cells of the memory devices. An external controller (e.g., memory sub-system controller) can externally manage the memory device (e.g., perform media management operations on the memory device). In some embodiments, a memory device is a managed memory device, which is a raw memory device combined with a local media controller for media management within the same memory device package. An example of a managed memory device is a managed NAND (MNAND) device.

The controller or a memory device can include a storage manager configured to implement storage functions discussed above. In some embodiments, the controller in the memory sub-system includes at least a portion of the storage manager. In other embodiments, or in combination, the controller or the processing device in the host system includes at least a portion of the storage manager. For example, the controller, the controller, or the processing device can include logic circuitry implementing the storage manager. For example, the controller, or the processing device (processor) of the host system, can be configured to execute instructions stored in memory for performing the operations of the storage manager described herein. In some embodiments, the storage manager is implemented in an integrated circuit chip disposed in the memory sub-system. In other embodiments, the storage manager can be part of the firmware of the memory sub-system, an operating system of the host system, a device driver, or an application, or any combination therein.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
storing weight data configured to weigh on image data;
receiving first data representative of a first portion of an image;
determining, based on a location of the first portion within the image, a first quantization level;
quantizing the first data according to the first quantization level;
quantizing the weight data according to the first quantization level; and
applying one or more operations of multiplication and accumulation to the first data and the weight data with the first quantization level to generate a first result.

2. The method of claim 1, further comprising:
providing the first result as an input to a set of artificial neurons in an artificial neural network trained to recognize, extract, identify, or classify one or more objects captured in image data.

3. The method of claim 2, further comprising:
receiving second data representative of a second portion of the image;
determining, based on a location of the second portion within the image, a second quantization level;
quantizing the second data according to the second quantization level;
quantizing the weight data according to the second quantization level; and
applying multiplication and accumulation to the second data and the weight data with the second quantization level to generate a second result.

4. The method of claim 3, wherein when the location of the first portion is closer to a center of the image than the location of the second portion, the first quantization level is more accurate than the second quantization level.

5. The method of claim 3, further comprising:
determining, in the image, a center of focus of a user, wherein when the location of the first portion is closer to the center of focus in the image than the location of the second portion, the first quantization level is more accurate than the second quantization level.

6. The method of claim 3, wherein the first quantization level is configured to identify a first predetermined number of least significant bits for exclusion in computation; and the first quantization level is configured to identify a second predetermined number of least significant bits for exclusion in computation.

7. The method of claim 6, wherein the applying of multiplication and accumulation to the first data and the weight data with the first quantization level is performed via:
skipping operations on least significant bits, of the first predetermined number, in the first data; and
skipping reading one or more columns of the first memory cells storing least significant bits, of the first predetermined number, in the weight data.

8. A device, comprising:
an array of memory cells programmable in a first mode to support multiplication and accumulation;
voltage drivers; and
a logic circuit configured to:
program, using the voltage drivers and in the first mode, first memory cells in the array to store weight data of an artificial neural network trained to analyze an image;
receive first data representative of a first portion of the image;
determine, based on a location of the first portion within the image, a first quantization level; and
apply multiplication and accumulation to the first data and the weight data with the first quantization level to generate a first result in the artificial neural network.

9. The device of claim 8, further comprising:
a first integrated circuit die having an image sensing pixel array configured to capture the image;
a second integrated circuit die having the array of memory cells;
a third integrated circuit die having the logic circuit; and
an integrated circuit package configured to enclose the first integrated circuit die, the second integrated circuit die, and the third integrated circuit die.

10. The device of claim 9, wherein the image sensing pixel array is configured to generate the first data and a second data representative of a second portion of the image; and the logic circuit is further configured to:
determine, based on a location of the second portion within the image, a second quantization level; and
apply multiplication and accumulation to the second data and the weight data with the second quantization level to generate a second result in the artificial neural network.

11. The device of claim 10, wherein the first quantization level is configured to be more accurate than the second quantization level, when the location of the first portion is closer to a center of the image than the location of the second portion.

12. The device of claim 10, wherein the logic circuit is further configured to:
determine, in the image, a center of focus of a user, wherein the first quantization level is configured to be more accurate than the second quantization level, when the location of the first portion is closer to the center of focus in the image than the location of the second portion.

13. The device of claim 10, wherein the first quantization level is configured to identify a first predetermined number of least significant bits for exclusion in computation; and the first quantization level is configured to identify a second predetermined number of least significant bits for exclusion in computation.

14. The device of claim 13, wherein the logic circuit is further configured to:
skip reading the first memory cells according to least significant bits, of the first predetermined number, in the first data; and
read, using the voltage drivers, one or more columns of the first memory cells without reading one or more columns of memory cells storing least significant bits, of the first predetermined number, in the weight data.

15. An apparatus, comprising:
a pair of augmented reality glasses, having:
a digital camera configured to capture an image of a field of view; and
a processing device configured to perform an analysis of the image using an artificial neural network having weight data;
wherein the processing device is further configured to apply different quantization levels to data from different regions of the image, and apply the different quantization levels to the weight data in weighing on the data from the different regions respectively; and
wherein the apparatus is configured to present, based on an output of the artificial neural network responsive to the image and via the pair of augmented reality glasses, content superimposed on a view through the pair of augmented reality glasses.

16. The apparatus of claim 15, wherein the pair of augmented reality glasses is configured with an integrated circuit device having:
an image sensing pixel array of the digital camera;
a logic circuit of at least a portion of the processing device; and
an array of memory cells programmable in a first mode to store the weight data.

17. The apparatus of claim 16, wherein the different quantization levels are configured to be more accurate in a center region of the image than in a peripheral region of the image.

18. The apparatus of claim 17, wherein the logic circuit is further configured to:
skip reading the memory cells in the array according to least significant bits, of numbers identified by the different quantization levels, in the data from the different regions; and
read, using voltage drivers, one or more columns of the first memory cells without reading one or more columns of memory cells storing least significant bits, of the numbers identified by the different quantization levels, in the weight data.

19. The apparatus of claim 18, wherein each respective memory cell in the array is:
programmable in the first mode to output:
a predetermined amount of current in response to a predetermined read voltage when the respective memory cell has a threshold voltage programmed to represent a value of one; or
a negligible amount of current in response to the predetermined read voltage when the threshold voltage is programmed to represent a value of zero; and
programmable in a second mode to have a threshold voltage positioned in one of a plurality of voltage regions, each representative of one of a plurality of predetermined values.

20. The apparatus of claim 19, wherein the first memory cells are connected between wordlines and bitlines; and the logic circuit is configured to:
convert, using voltage drivers connected to the wordlines and into output currents of the first memory cells summed in the bitlines, results of bitwise multiplications of bits in an input and bits stored in the first memory cells;
digitize, using current digitizers connected to the bitlines, currents in the bitlines to obtain column outputs; and
generate results of an operation of multiplication and accumulation applied to the input and the weight data stored in the first memory cells.
